(19) United States
(12) Patent Application Publication
(10) Pub. No.: US 2023/0213060 A1
(43) Pub. Date: Jul. 6, 2023

(54) JOURNAL BEARING AND ROTARY MACHINE

(71) Applicant: MITSUBISHI HEAVY INDUSTRIES, LTD., Tokyo (JP)

(72) Inventors: Shimpei YOKOYAMA, Tokyo (JP); Yoshitomo NODA, Tokyo (JP); Chihiro YOSHIMINE, Tokyo (JP); Takuzo SHIGIHARA, Tokyo (JP)

(73) Assignee: MITSUBISHI HEAVY INDUSTRIES, LTD., Tokyo (JP)

(21) Appl. No.: 17/927,814

(22) PCT Filed: Apr. 13, 2021
(86) PCT No.: PCT/JP2021/015321

§ 371 Date: Nov. 25, 2022

(30) Foreign Application Priority Data
May 29, 2020 (JP) 2020-093944

(51) Int. Cl. F16C 17/03

(52) U.S. Cl. CPC F16C 17/035

(57) ABSTRACT

Provided are a journal bearing and a rotary machine, including: a housing that has an annular shape and is disposed around a rotating shaft; a plurality of bearing pads that are disposed between the housing and the rotating shaft to be spaced from each other at predetermined intervals in the circumferential direction of the housing; and a support that supports at least one end of each bearing pad in the axial direction of the rotating shaft to allow the each bearing pad to swing in the housing about an axis serving as a fulcrum in parallel to the axial direction.

### FIELD

The present disclosure relates to a journal bearing that is to be applied to rotary machines including compressors such as centrifugal compressors and multi-shaft multi-stage compressors and driving turbines such as steam turbines and gas turbines, and relates to a rotary machine including the journal bearing.

### BACKGROUND

Examples of a device configured to support a rotating shaft of a rotary machine include a journal bearing. Examples of the journal bearing include a tilting-pad bearing. The tilting-pad bearing includes: a housing; and a plurality of bearing pads disposed along a circumferential direction inside a housing and configured to rotatably support a rotating shaft. The tilting-pad bearing forms an oil film between the rotating shaft and the bearing pads and allows the bearing pads to swing, thereby supporting the rotating shaft. Thus, the tilting-pad bearing supports the rotating shaft via the oil film, thereby allowing the rotating shaft to rotate, and, even when the rotating shaft is excited, the tilting-pad bearing can reduce vibration of the rotating shaft with the damping effect of the oil film.

Examples of the above-described journal bearing (the tilting-pad bearing) include a journal bearing described in Patent Literature 1. In the journal bearing described in Patent Literature 1, outer peripheral portions of a plurality of bearing pads are supported by positioning pins protruding from a housing.

### CITATION LIST

### Patent Literature

Patent Literature 1: Japanese Patent No. 6452010

### SUMMARY

### Technical Problem

As described above, a conventional journal bearing is configured such that outer peripheral portions of a plurality of bearing pads are point-supported (linearly supported) by positioning pins. However, because of the wear of the outer peripheral portions of the bearing pads or the play of the positioning pins, an appropriate distribution of the thickness of an oil film between the outer peripheral surface of the rotating shaft and the inner peripheral surfaces of the bearing pads is sometimes not formed. In this case, even the tilting-pad bearing, which is considered to be excellent in vibration stability, cannot reduce vibration of the rotating shaft, and accordingly there is a risk that asynchronous vibration may occur.

The present disclosure is to solve the above-described problem, and an object of the present disclosure is to provide a journal bearing and a rotary machine, in which the operation performance of bearing pads is enhanced and a rotating shaft is stably supported, whereby the occurrence of vibration can be reduced.

### Solution to Problem

To achieve the above-described object, a journal bearing according to the present disclosure includes: a housing that has an annular shape and is disposed around a rotating shaft; a plurality of bearing pads that are disposed between the housing and the rotating shaft to be spaced from each other at predetermined intervals in a circumferential direction of the housing; and a support that supports at least one end of each bearing pad in an axial direction of the rotating shaft to allow the each bearing pad to swing in the housing about an axis serving as a fulcrum in parallel to the axial direction.

A rotary machine according to the present disclosure includes: a rotating shaft; and the above-described journal bearing that rotatably supports the rotating shaft.

### Advantageous Effects of Invention

With the journal bearing and the rotary machine of the present disclosure, the operation performance of the bearing pads is enhanced and the rotating shaft is stably supported, whereby the occurrence of vibration can be reduced.

### BRIEF DESCRIPTION OF DRAWINGS

FIG. 1 is a schematic diagram illustrating a journal bearing according to a first embodiment.

FIG. 2 is a cross-sectional view taken along line II-II in FIG. 1, the view illustrating a cross section of a principal part of the journal bearing.

FIG. 3 is a cross-sectional view taken along line III-III in FIG. 1, the view illustrating a support in the bearing pad.

FIG. 4 is a cross-sectional view similar to FIG. 3, the view illustrating a modification example of the support in the bearing pad.

FIG. 5 is a schematic diagram illustrating a journal bearing according to a second embodiment.

FIG. 6 is a cross-sectional view taken along line VI-VI in FIG. 5, the view illustrating a principal part of the journal bearing.

### DESCRIPTION OF EMBODIMENTS

Hereinafter, preferred embodiments of the present disclosure will be described in detail with reference to the drawings. Note that the present disclosure shall not be limited by the embodiments, and, in the case where a plurality of embodiments is present, combinations of the embodiments are included. Constituents in the embodiments include constituents what can be easily assumed by those skilled in the art, and constituents that are substantially the same, in other words, constituents in the range of equivalents.

### First Embodiment

### Configuration of Journal Bearing

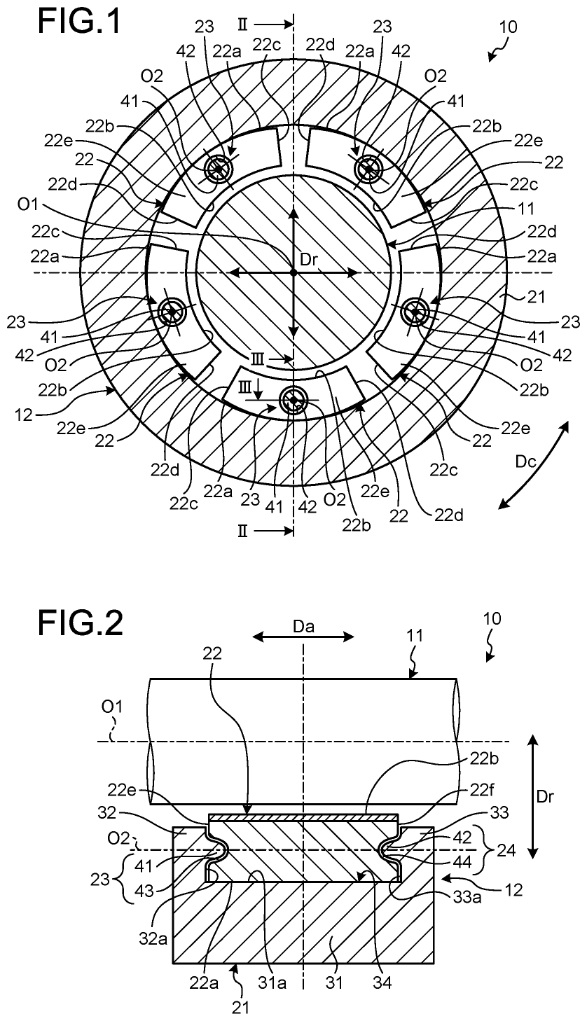

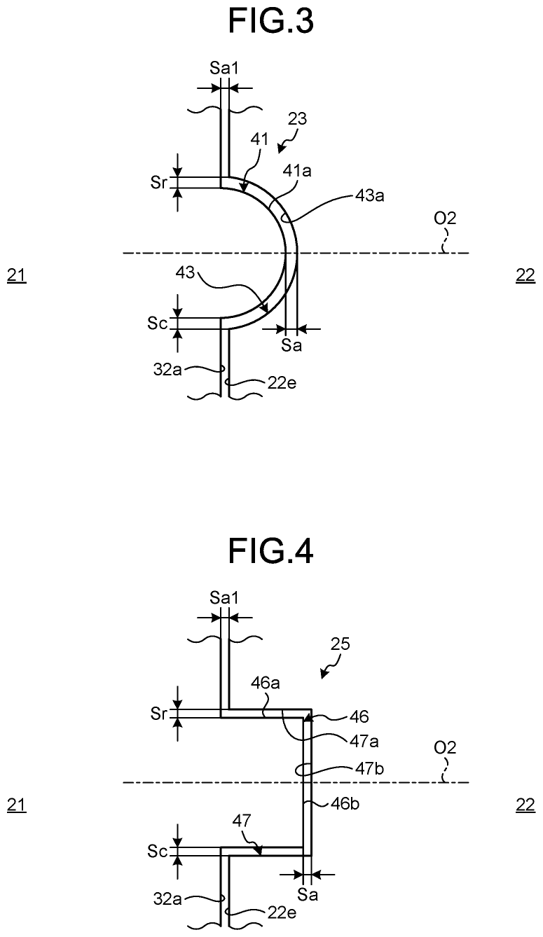

FIG. 1 is a schematic diagram illustrating a journal bearing according to a first embodiment. FIG. 2 is a cross-sectional view taken along line II-II in FIG. 1, the view illustrating a principal part of the journal bearing. FIG. 3 is a cross-sectional view taken along line III-III in FIG. 1, the view illustrating a support in a bearing pad. Note that, in the following descriptions of the embodiments, the axial direction of the rotating shaft is referred to as the Da direction, the radial direction of the rotating shaft is referred to as the Dr direction, and the circumferential direction of the rotating shaft is referred to as the Dc direction.

In the first embodiment, a rotary machine 10 includes a rotating shaft 11 and a journal bearing 12 as illustrated in FIGS. 1 and 2. The rotary machine 10 is, for example, but not limited to, a compressor or a driving turbine. The journal bearing 12 is configured to rotatably support the rotating shaft 11. The rotating shaft 11 has a cylindrical shape and is capable of rotating about an axis O1 extending in the Da direction.

The journal bearing 12 is a tilting-pad bearing. The journal bearing 12 includes a housing 21, a plurality of bearing pads 22 (five bearing pads in the present embodiment), and two supports 23, 24. Note that the number of bearing pads 22 is not limited to five, but may be four or fewer or may be six or more. The number of the supports 23, 24 are not limited to two disposed in the axial direction, but may be one disposed on only one side in the axial direction.

The housing 21 has an annular shape. The housing 21 includes a housing body 31 and a pair of side walls 32, 33. The housing body 31 has an annular shape and is rectangular in cross section. The paired side walls 32, 33 have an annular shape, and are rectangular in cross section. The paired side walls 32, 33 are respectively disposed at one end and the other end of the housing body 31 in the Da direction. The paired side walls 32, 33 are disposed in the Dr direction from an inner peripheral portion of the housing body 31 toward the axis O1. The housing 21 has a U-shaped cross section formed by the housing body 31 and the paired side walls 32, 33. The paired side walls 32, 33 are the same in shape. Note that the housing body 31 and the paired side walls 32, 33 may be provided separately and then fixed together, or may be integrally provided.

The housing 21 is provided with a housing recess 34 having an annular shape formed by an inner peripheral surface 31a of the housing body 31 and end surfaces 32a, 33a of the paired side walls 32, 33. The housing recess 34 is opened toward the axis O1.

The five bearing pads 22 are disposed between the housing 21 and the rotating shaft 11 so as to be spaced from each other at predetermined intervals in the Dc direction of the housing 21. The five bearing pads 22 are disposed in the housing recess 34 of the housing 21. Each of the bearing pads 22 has an arc shape and includes an outer peripheral surface 22a, an inner peripheral surface 22b, side surfaces 22c, 22d, and end surfaces 22e, 22f. The radius of curvature of the outer peripheral surface 22a of the bearing pad 22 is smaller than the radius of curvature of the inner peripheral surface of the housing 21 (the inner peripheral surface 31a of the housing body 31). The radius of curvature of the inner peripheral surface 22b of the bearing pad 22 is the same as or larger than the radius of curvature of the outer peripheral surface of the rotating shaft 11. The side surfaces 22c, 22d of the bearing pad 22 are flat, and a predetermined gap is secured between the side surfaces 22c, 22d of the bearing pad 22 and side surfaces 22c, 22d of another bearing pad 22 adjacent to the bearing pad 22 in the Dc direction. The end surfaces 22e, 22f of the bearing pad 22 are flat. The five bearing pads 22 have the same shape.

The supports 23, 24 support at least one end of the bearing pad 22 in the Da direction so as to allow the bearing pad 22 to swing in the housing 21 about an axis O2 serving as a fulcrum in parallel to the Da direction. In a tenth embodiment, supports 23, 24 respectively support one end and the other end of the bearing pad 22 in the Da direction so as to allow the bearing pad 22 to swing in the housing 21. The supports 23 and 24 not only support the bearing pad 22 so as to allow the bearing pad 22 to swing in the housing 21, but also position the bearing pad 22 with respect to the housing 21.

The supports 23, 24 include projections 41, 42 provided in the housing 21 and recesses 43, 44 provided in the bearing pad 22, respectively. The projections 41, 42 are provided in the end surfaces 32a, 33a of the side walls 32, 33, respectively. The recesses 43, 44 are provided in the end surfaces 22e, 22f of the bearing pad 22, respectively.

As illustrated in FIGS. 1 and 3, the projections 41, 42 have a hemispherical projecting shape, and the recesses 43, 44 have a hemispherical recessed shape. The projections 41, 42 are inserted into the recesses 43, 44. A predetermined gap Sr is provided in the Dr direction between the outer surfaces 41a, 42a of the projections 41, 42 and the inner surfaces 43a, 44a of the recesses 43, 44;

and a predetermined gap Sc is provided in the Dc direction between the outer surfaces 41a, 42a of the projections 41, 42 and the inner surfaces 43a, 44a of the recesses 43, 44. Furthermore, a predetermined gap Sa is provided in the Da direction between the outer surfaces 41a, 42a of the projections 41, 42 and the inner surfaces 43a, 44a of the recesses 43, 44. Here, the predetermined gap Sr and the predetermined gap Sc are swing allowances that allow the bearing pad 22 to swing about the axis O2 serving as a fulcrum in the housing 21. On the other hand, the predetermined gap Sa is a gap that allows the bearing pad 22 to swing about the axis O2 serving as a fulcrum in the housing 21, and is preferably smaller than the predetermined gap Sr and the predetermined gap Sc. Note that the predetermined gap Sa is equivalent to a gap Sa1 between the end surfaces 32a, 33a of the side walls 32, 33 and the end surfaces 22e, 22f of the bearing pad 22.

A position at which the bearing pad 22 is supported by the supports 23, 24, that is, the axis O2 serving as a center of the swing of the bearing pad 22 is in the middle of the bearing pad 22 in the Dr direction. However, the axis O2 may be positioned in the outside with respect to the middle of the bearing pad 22 in the Dr direction, that is, may be positioned on the outer peripheral surface 22a side.

Note that the shape of the supports 23, 24 is not limited to the above-described shape. FIG. 4 is a cross-sectional view similar to FIG. 3, the view illustrating a modification example of the supports in the bearing pad.

As illustrated in FIG. 4, a support 25 includes a projection 46 provided in the housing 21 and a recess 47 provided in the bearing pad 22. The projection 46 is provided in the end surface 32a of the side wall 32. The recess 47 is provided in the end surface 22e of the bearing pad 22.

As illustrated in FIGS. 1 and 3, the projection 46 has a cylindrically projecting shape and the recess 47 has a cylindrically recessed shape. The projection 46 is inserted into the recess 47. In this case, an end surface 46b of the projection 46 and a bottom surface 47b of the recess 47 are flat, but the end surface 46b may be a hemispherical projection meanwhile the bottom surface 47b may be a hemispherical recess. A predetermined gap Sr is provided in the Dr direction between an outer peripheral surface 46a of the projection 46 and an inner peripheral surface 47a of the recess 47, and a predetermined gap Sc is provided in the Dc direction between the outer peripheral surface 46a of the projection 46 and the inner peripheral surface 47a of the recess 47. Furthermore, a predetermined gap Sa is provided in the Da direction between the end surface 46b of the projection 46 and the bottom surface 47b of the recess 47. Note that the predetermined gap Sa is equivalent to a gap Sal between the end surface 32a of the side wall 32 and the end surface 22e of the bearing pad 22.

The supports 23, 24, 25 is not limited to the above-described shape. The shapes of the projections 41, 42, 46 and the recesses 43, 44, 47 may be, for example, a cone or frustum as long as those structures have a play that allows the circumferential positioning of the pad in the circumferential direction and allows the pad to swing. Furthermore, the recesses 43, 44, 47 may be provided in the housing 21, and the projections 41, 42, 46 may be provided in the bearing pad 22.

Note that the journal bearing 12 is provided with an oil supply device not illustrated, the oil supply device being configured to supply a lubricating oil between the outer peripheral surface of the rotating shaft 11 and the inner peripheral surfaces 22b of the bearing pads 22 from the outside. The oil supply device is configured, for example, such that an oil supply pipe penetrates the housing 21 from the outside and is also laid in a space between the bearing pads 22. The number of the oil supply pipe to be laid is not limited to one, but may be two or more. Thus, the lubricating oil is supplied through the oil supply pipe to the outer peripheral surface of the rotating shaft 11 and the inner peripheral surface 22b of the bearing pads 22, and regions around the bearing pads 22 are filled with the lubricating oil.

### Operation of Journal Bearing

As illustrated in FIGS. 1 and 2, with the journal bearing 12 disposed around the rotating shaft 11, the lubricating oil is supplied between the rotating shaft 11 and the bearing pads 22, whereby an oil film is formed between the outer peripheral surface of the rotating shaft 11 and the inner peripheral surfaces 22b of the bearing pads 22. Here, when the rotating shaft 11 vibrates in the Dr direction, the bearing pads 22 support the rotating shaft 11 while swinging about the axis O2 serving as a fulcrum in accordance with the rotating shaft 11. Thus, the bearing pads 22 positioned below the rotating shaft 11 can appropriately operate under a load of the rotating shaft 11, stably support the rotating shaft 11, and reduce vibration of the rotating shaft 11. Furthermore, the bearing pads 22 positioned above the rotating shaft 11 can appropriately operate under their own weight in accordance with a deviation of the rotating shaft 11, and thereby the bearing pads 22 are capable of stably supporting the rotating shaft 11.

### Second Embodiment

FIG. 3 is a schematic diagram illustrating a journal bearing according to a second embodiment. FIG. 4 is a cross-sectional view taken along line IV-VI in FIG. 3, the view illustrating a principal part of the journal bearing. Note that constituents having the same functions as those of the above-described constituents in the first embodiment will be given the same reference numerals, and detailed descriptions thereof will be omitted.

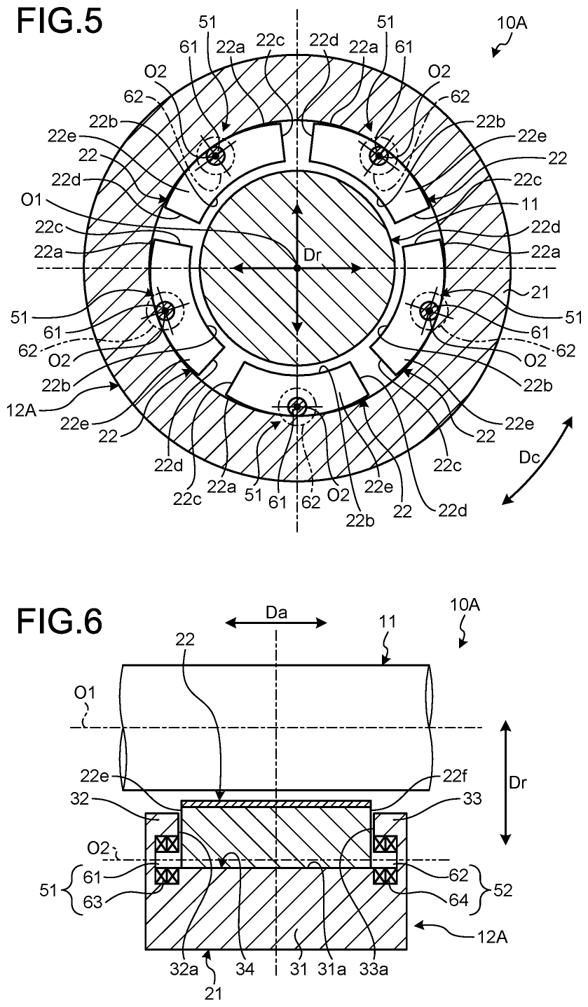

In the first embodiment, a rotary machine 10A includes a rotating shaft 11 and a journal bearing 12A, as illustrated in FIGS. 5 and 6. The journal bearing 12 is configured to rotatably support the rotating shaft 11. The rotating shaft 11 has a cylindrical shape and is capable of rotating about an axis O1 extending in the Da direction.

The journal bearing 12A is a tilting-pad bearing. The journal bearing 12A includes a housing 21, a plurality of bearing pads 22 (five bearing pads in the present embodiment), and two supports 51, 52.

The housing 21 includes a housing body 31 and a pair of side walls 32, 33. A housing recess 34 is provided in the housing 21. The five bearing pads 22 are disposed in the housing recess 34 of the housing 21.

The supports 51, 52 support at least one end of the bearing pad 22 in the Da direction so as to allow the bearing pad 22 to swing in the housing 21 about an axis O2 serving as a fulcrum in parallel to the Da direction. In the second embodiment, the supports 51, 52 support one end and the other end of the bearing pad 22 in the Da direction, respectively, so as to allow the bearing pad 22 to swing in the housing 21. The supports 51 and 52 not only support the bearing pad 22 so as to allow the bearing pad 22 to swing in the housing 21, but also position the bearing pad 22 with respect to the housing 21.

The supports 51, 52 respectively include: shafts 61, 62 provided in the bearing pad 22; and bearings 63, 64 provided in the housing 21 and rotatably supporting the shafts 61, 62. The shafts 61, 62 are disposed in end surfaces 22e, 22f of the bearing pad 22, respectively. The bearings 63, 64 are disposed in end surfaces 32a, 33a of the side walls 32, 33, respectively. The shafts 61, 62 are disposed to project from the end surfaces 22e, 22f of the bearing pad 22 in the Da direction toward the side walls 32, 33. The bearings 63, 64 are disposed inside the side walls 32, 33. The end surfaces of the bearing pad 22 are continuous with the end surfaces 32a, 33a, respectively, without a difference in level. The bearings 63, 64 are preferably rolling bearings, but may be other types of bearings.

A position at which the bearing pad 22 is supported by the supports 51, 52, that is, the axis O2 serving as a center of the swing of the bearing pad 22 is in the outside in the Dr direction with respect to the middle of the bearing pad 22 in the Dr direction. Note that the axis O2 may be positioned in the middle of the bearing pad 22 in the Dr direction.

Note that the shape of the supports 51, 52 is not limited to the above-described shape. The housing 21 may have the shafts 61, 62, meanwhile the bearing pad 22 may have the bearings 63, 64 configured to rotatably support the shafts 61, 62.

An operation of the journal bearing 12A according to the second embodiment is almost the same as that of the journal bearing 12 according to the first embodiment, and therefore descriptions thereof will be omitted.

### Functions and Effects of the Embodiments

A journal bearing according to a first aspect includes: a housing 21 having an annular shape and configured to be disposed around a rotating shaft 11; a plurality of bearing pads 22 disposed between the housing 21 and the rotating shaft 11 to be spaced from each other at predetermined intervals in the circumferential direction of the housing 21; and supports 23, 24, 25, 51, 52 supporting at least one end of the bearing pads 22 in the Da direction (in the direction of an axis O1 of the rotating shaft 11) so as to allow the bearing pads 22 to swing in the housing 21 about an axis O2 serving as a fulcrum, in parallel to the axis O1 direction.

In the journal bearing according to the first aspect, the supports 23, 24, 25, 51, 52 support the end of the bearing pad 22 in the Da direction so as to allow the bearing pad 22 to swing about the axis O2 serving as a fulcrum in parallel to the axis O1 direction. Thus, the operation performance of the bearing pad 22 is enhanced, so that the rotating shaft 11 is stably supported, whereby the occurrence of vibration can be reduced.

In a journal bearing according to a second aspect, supports 23, 24, 25, 51, 52 support one end and the other end of the bearing pad 22 in the Da direction so as to allow the bearing pad 22 to swing. Thus, the bearing pad 22 can be stably supported by the supports 23, 24, 25, 51, 52.

In a journal bearing according to a third aspect, supports 23, 24, 25 respectively include: projections 41, 42, 46 provided on one side of a housing 21 and bearing pads 22; and recesses 43, 44, 47 provided on the other side of the housing 21 and the bearing pads 22. Thus, the bearing pads 22 can be stably supported with a simple configuration.

In a journal bearing according to a fourth aspect, projections 41, 42, 46 are inserted into recesses 43, 44, 47, respectively. Predetermined gaps Sr, Sc are provided at least in the Dr and Dc directions between the projections 41, 42, 46 and the recesses 43, 44, 47. Thus, an allowance for the swing of bearing pads 22 in the Dr and

Dc directions in the housing 21 can be secured, whereby the operation performance of the bearing pads 22 is enhanced, so that the rotating shaft 11 can be stably supported.

In a journal bearing according to a fifth aspect, projections 41, 42 have a hemispherical projecting shape and recesses 43, 44 have a hemispherical recessed shape. Thus, the operation performance of each bearing pad 22 can be enhanced.

In a journal bearing according to a sixth aspect, a projection 46 has a cylindrically projecting shape and a recess 47 has a cylindrically recessed shape. Thus, the operation performance of each bearing pad 22 can be enhanced.

In a journal bearing according to a seventh aspect, supports 51, 52 respectively include: shafts 61, 62 provided on one side of a housing 21 and bearing pads 22; and bearings 63, 64 provided on the other side of the housing 21 and the bearing pads 22 and rotatably supporting the shafts 61, 62. Thus, the operation stability of the bearing pads 22 can be enhanced.

In a journal bearing according to an eighth aspect, a position at which a bearing pad 22 is supported by supports 23, 24, 25 is in the middle of the bearing pads 22 in the Dr direction. Thus, each bearing pad 22 can be stably supported.

In a journal bearing according to a ninth aspect, a position at which a bearing pad 22 is supported by supports 51, 52 is in the outside in the Dr direction with respect to the middle of the bearing pad 22 in the Dr direction. Thus, each bearing pad 22 can be stably supported.

A rotary machine according to a tenth aspect includes: a rotating shaft 11; and a journal bearing 12 rotatably supporting the rotating shaft 11. Thus, the operation performance of bearing pads 22 is enhanced, so that the rotating shaft 11 is stably supported, whereby the occurrence of vibration can be reduced.

### REFERENCE SIGNS LIST

10, 10A Rotary machine
11 Rotating shaft
12, 12A Journal bearing

### 21 Housing

### 22 Bearing pad

22a Outer peripheral surface
22b Inner peripheral surface
22c, 22d Side surface
22e, 22f End surface

### 23, 24, 25, 51, 52 Support

31 Housing body
31a Inner peripheral surface
32, 33 Side wall
32a, 33a End surface
34 Housing recess

### 41, 42, 46 Projection

41a Outer surface

### 43, 44, 47 Recess

43a Inner surface
46a Outer peripheral surface
46b End surface
47a Inner peripheral surface
47b Bottom surface

### 61, 62 Shaft

### 63, 64 Bearing

### O1, O2 Axis

### Sa, Sr, Sc Predetermined gap

### Sa1 Gap

1. A journal bearing, comprising:
a housing that has an annular shape and is disposed around a rotating shaft;
a plurality of bearing pads that are disposed between the housing and the rotating shaft to be spaced from each other at predetermined intervals in a circumferential direction of the housing; and
a support that supports at least one end of each bearing pad in an axial direction of the rotating shaft to allow the each bearing pad to swing in the housing about an axis serving as a fulcrum in parallel to the axial direction, wherein
the support includes
a projection that is provided on one of the housing and each bearing pad, and
a recess that is provided on another of the housing and the each bearing pad, the projection is inserted into the recess,
an axial gap is provided between the projection and the recess along an axial direction of the rotating shaft, and
the axial gap is equivalent to a gap between an end surface of a side wall of the housing and an end surface of the bearing pad.

2. The journal bearing according to claim 1, wherein the support supports the one end of and another end of each bearing pad in the axial direction so as to allow the bearing pad to swing.

3. (canceled)

4. (canceled)

5. The journal bearing according to claim 1, wherein the projection has a hemispherical projecting shape and the recess has a hemispherical recessed shape.

6. The journal bearing according to claim 1, wherein the projection has a cylindrically projecting shape and the recess has a cylindrically recessed shape.

7. (canceled)

8. The journal bearing according to claim 1, wherein a position at which each bearing pad is supported by the support is in middle of the each bearing pad in the radial direction of the rotating shaft.

9. The journal bearing according to claim 1, wherein a position at which the bearing pad is supported by the support is in the outside in the radial direction with respect to the rotating shaft with respect to the middle of the bearing pad in the radial direction of the rotating shaft.

10. A rotary machine, comprising:
a rotating shaft; and
the journal bearing according to claim 1 that rotatably supports the rotating shaft.
